(19) United States
(12) Patent Application Publication
(10) Pub. No.: US 2003/0070088 A1
(43) Pub. Date: Apr. 10, 2003

(54) Computer virus names cross-reference and information method and system

(76) Inventor: Dmitry Gryaznov, Portland, OR (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/970,770

(22) Filed: Oct. 5, 2001

(51) Int. Cl. G06F 11/30

(52) U.S. Cl. 713/201

(57) ABSTRACT

A method, system, and computer program product for cross-referencing computer malwares that provides the capability to determine multiple names of a given malware, distinguish different malwares having the same names, and automatically gather information relating to such malwares. A method of cross-referencing computer malwares comprises the steps of searching a database for a name of a computer malware, retrieving at least one alternate name of the computer malware, accessing a link associated with the at least one alternate name, and searching a Web site pointed to by the link for information relating to the computer malware using the alternate name.

### FIELD OF THE INVENTION

The present invention relates to a cross-reference of names of computer malwares that includes links to Web sites that include information relating to the computer malwares.

### BACKGROUND OF THE INVENTION

As the popularity of the Internet has grown, the proliferation of computer malware has become more common. A typical computer malware is a program or piece of code that is loaded onto a computer and/or performs some undesired actions on a computer without the knowledge or consent of the computer operator. The most widespread, well-known and dangerous type of computer malware are computer viruses, that is, programs or pieces of code that replicate themselves and load themselves onto other connected computers. Once the virus has been loaded onto the computer, it is activated and may proliferate further and/or damage the computer or other computers.

Along with the proliferation of computer viruses and other malware has come a proliferation of software to detect and remove such viruses and other malware. This software is generically known as anti-virus software or programs. In order to detect a virus or other malicious program, an anti-virus program typically scans files stored on disk in a computer system and/or data that is being transferred or downloaded to a computer system and compares the data being scanned with profiles that identify various kinds of malware. The anti-virus program may then take corrective action, such as notifying a user or administrator of the computer system of the virus, isolating the file or data, deleting the file or data, etc.

Currently, there are dozens of different anti-virus programs and over 60,000 different computer viruses and other malware programs in existence. This proliferation of computer malwares and anti-virus programs causes a problem. Often, different anti-virus programs call the same virus different names, so that given just the name of the virus, as reported by the anti-virus program, it is difficult to know which virus is actually present. For example, a particular mass-mailing virus that achieved significant proliferation was called “Kournikova”, “VBS/SST”, “SBS/VBSWG.J”, “Kalamar”, and a number of other names by different anti-virus programs. These multiple names present a significant problem for users of anti-virus programs, as well as for technical support operators who deal with the users.

An additional problem arises in that different anti-virus programs may call different computer malwares the same name. In this situation, providing just the name of a virus is not sufficient. Virus descriptions must be compared to determine which virus is which. These virus descriptions may not be available in a central location, requiring searching of many different information sources to obtain the necessary information.

A need arises for a technique by which multiple names of a given virus can be determined, different malwares having the same names can be distinguished, and information relating to such malwares can be automatically gathered.

### SUMMARY OF THE INVENTION

The present invention is a method, system, and computer program product for cross-referencing computer malwares that provides the capability to determine multiple names of a given malware, distinguish different malwares having the same names, and automatically gather information relating to such malwares.

In one embodiment of the present invention, a method of cross-referencing computer malwares comprises the steps of searching a database for a name of a computer malware, retrieving at least one alternate name of the computer malware, and providing a link associated with the at least one alternate name. The method may further comprise the step of searching a Web site pointed to by the link for information relating to the computer malware using the alternate name. The computer malware may comprise at least one of a computer virus, a computer worm, or a computer Trojan horse program. The method may further comprise the step of retrieving a description of the computer malware. The method may further comprise the step of displaying the information relating to the computer malware found using the alternate name. The method may further comprise the step of searching at least one additional Web site using the name of the computer malware. The method may further comprise the step of searching at least one additional Web site using at least one alternate name of the computer malware. The method may further comprise the step of performing a general search of the Internet using the name of the computer malware. The method may further comprise the step of performing a general search of the Internet using at least one alternate name of the computer malware. The method may further comprise the step of performing a general search of the Internet using a plurality of alternate names of the computer malware.

In one aspect of the present invention, the method further comprises the step of displaying the information relating to the computer malware found using the alternate name. The method may further comprise the step of searching at least one additional Web site using the name of the computer malware. The method may further comprise the step of searching at least one additional Web site using at least one alternate name of the computer malware.

In one embodiment of the present invention, a computer malware cross-reference comprises a plurality of names of computer malwares, at least one alternate name of a computer malware associated with at least one of the plurality of names of computer malwares, at least one link to a Web site associated with the at least one alternate name of the computer malware. The computer malware may comprise at least one of a computer virus, a computer worm, or a computer Trojan horse program. The computer malware cross-reference may further comprise a description of the computer malware.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a typical system incorporating the present invention.

FIG. 2 is a block diagram of an exemplary computer system, in which the present invention may be implemented.

FIG. 3 is an exemplary flow diagram of a process of operation of an update control program shown in FIG. 3.

FIG. 4 is an exemplary format of an embodiment of virus database shown in FIG. 1

### DETAILED DESCRIPTION OF THE INVENTION

A typical computer malware is a program or piece of code that is loaded onto a computer and/or performs some undesired actions on a computer without the knowledge or consent of the computer operator. Types of malware include computer viruses, Trojan horse programs, and other content. One widespread, well-known and dangerous type of computer malware are computer viruses, that is, programs or pieces of code that replicate themselves and load themselves onto other connected computers. Once the virus has been loaded onto the computer, it is activated and may proliferate further and/or damage the computer or other computers. A particular type of computer virus is the computer worm, which is a program or code that replicates itself over a computer network and may performs malicious actions, such as using up the computer's resources and possibly shutting the system down. A Trojan horse program is typically a destructive program that masquerades as a benign application. Unlike a virus, Trojan horses do not replicate themselves but they can be just as destructive. One insidious type of Trojan horse is a program that claims to rid a computer of malwares but instead introduces malwares onto the computer.

In describing the present invention, the term virus is used for clarity. However, the term virus is used only as an example of malware and the present invention contemplates any and all types of malware.

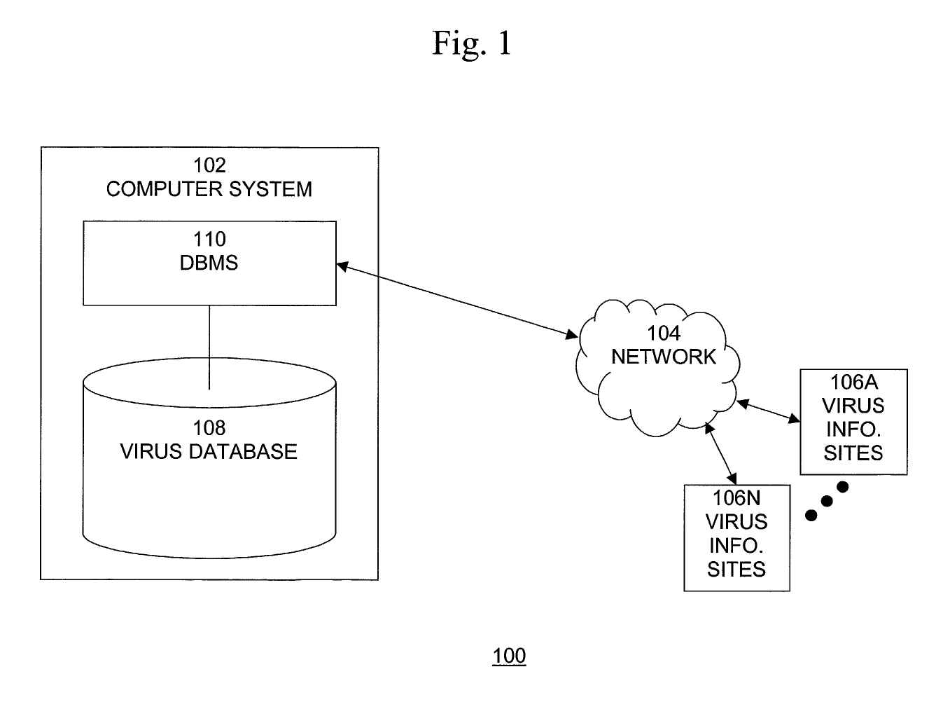

An exemplary block diagram of a typical system 100 incorporating the virus cross-reference system of the present invention is shown in FIG. 1. System 100 includes one or more computer systems, such as computer system 102, which are communicatively connected to a data communications network 104, such as a public data communications network, for example, the Internet, or a private data communications network, for example, a private intranet. Computer system 102 generates and transmits requests for information over network 104 to virus information sites, such as virus information sites 106A-N. Virus information sites are typically Web sites that are communicatively connected to a data communications network, such as network 104. Web sites are typically implemented by computer systems, such as Web servers, which store and retrieve information and/or perform processing in response to requests received from other systems. The requests for information or processing that are received, for example, by virus information site 106A, are processed and responses, typically including the requested information or results of the processing, are transmitted from virus update site 106A to the requesting computer system. Virus information sites are sites that contain information relating to computer malwares. Virus information sites are typically operated by vendors of anti-virus programs and include information about malwares that may be detected by the anti-virus programs. The virus information may be the only information stored in a virus information site, or the virus information may be stored along with any other information in a virus information site. Thus, computer system 102 can communicate with virus information sites, such as virus information site 106A, to request and receive virus information.

Other computers (not shown), such as user computer systems, servers, etc., may be connected to network 104. Where network 104 is an intranet, computer systems such as user workstations and proprietary servers are typically communicatively connected to network 104. Where network 104 is the Internet, computer systems such as Web servers, Internet service provider servers, and user personal computer systems and workstations are typically communicatively connected to network 104.

Computer system 102 includes virus database 108 and database management system (DBMS) 110. DBMS 110 provides the capability to store, organize, modify, and extract information from database virus database 108. From a technical standpoint, DBMSs can differ widely. The terms relational, network, flat, and hierarchical all refer to the way a DBMS organizes information internally. The internal organization can affect how quickly and flexibly you can extract information.

Virus database 102 includes a collection of information relating to computer malwares, which are organized in such a way that computer software can select and retrieve desired pieces of data. Traditional databases are organized by fields, records, and files. A field is a single piece of information; a record is one complete set of fields; and a file is a collection of records. An alternative concept in database design is known as Hypertext. In a Hypertext database, any object, whether it be a piece of text, a picture, or a film, can be linked to any other object. Hypertext databases are particularly useful for organizing large amounts of disparate information, but they are not designed for numerical analysis.

Typically, accesses to the database and store or retrieve data from the database are performed by functions, which are often termed queries, and are performed by using a database query language, such as structured query language (SQL). SQL is a standardized query language for requesting information from a database. Historically, SQL has been a popular query language for database management systems running on minicomputers and mainframes. Increasingly, however, SQL is being supported by personal computer database systems because it supports distributed databases (databases that are spread out over several computer systems). This enables several users on a local-area network to access the same database simultaneously.

Most full-scale database systems are relational database systems. Small database systems, however, use other designs that provide less flexibility in posing queries. Relational databases are powerful because they require few assumptions about how data is related or how it will be extracted from the database. As a result, the same database can be viewed in many different ways. An important feature of relational systems is that a single database can be spread across several tables. This differs from flat-file databases, in which each database is self-contained in a single table.

Anti-virus programs are software that scans files on disks of computer systems and/or data that is being transferred to computer systems to detect the presence of malwares. As new malwares are continually being generated, virus database 108 must continually be updated to include information relating to the newly generated malwares.

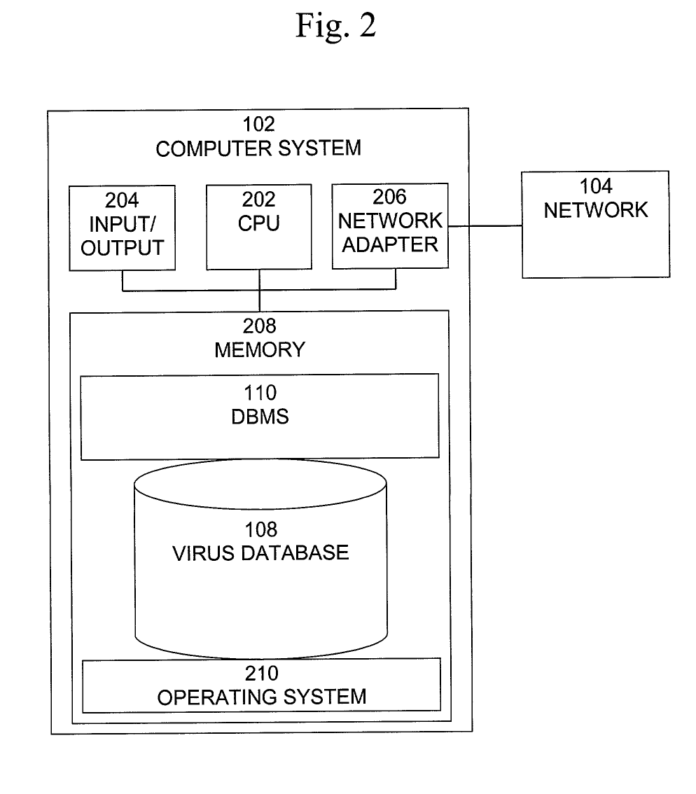

A block diagram of an exemplary computer system 200, in which the virus cross-reference system of the present invention may be implemented, is shown in FIG. 2. Computer system 200 is typically a programmed general-purpose computer system, such as a personal computer, workstation, server system, and minicomputer or mainframe computer. Computer system 200 includes processor (CPU) 202, input/output circuitry 204, network adapter 206, and memory 208. CPU 202 executes program instructions in order to carry out the functions of the present invention. Typically, CPU 202 is a microprocessor, such as an INTEL PENTIUM® processor, but may also be a minicomputer or mainframe computer processor. Although in the example shown in FIG. 2, computer system 200 is a single processor computer system, the present invention contemplates implementation on a system or systems that provide multi-processor, multi-tasking, multi-process, multi-thread computing, distributed computing, and/or networked computing, as well as implementation on systems that provide only single processor, single thread computing. Likewise, the present invention also contemplates embodiments that utilize a distributed implementation, in which computer system 200 is implemented on a plurality of networked computer systems, which may be single-processor computer systems, multi-processor computer systems, or a mix thereof.

Input/output circuitry 204 provides the capability to input data to, or output data from, computer system 200. For example, input/output circuitry may include input devices, such as keyboards, mice, touchpads, trackballs, scanners, etc., output devices, such as video adapters, monitors, printers, etc., and input/output devices, such as, modems, etc. Network adapter 206 interfaces computer system 200 with network 104. Network 104 may be any standard local area network (LAN) or wide area network (WAN), such as Ethernet, Token Ring, the Internet, or a private or proprietary LAN/WAN.

Memory 208 stores program instructions that are executed by, and data that are used and processed by, CPU 202 to perform the functions of the present invention. Memory 208 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc., or a fiber channel-arbitrated loop (FC-AL) interface.

Memory 208 includes virus database 108, database management system (DBMS) 110, and operating system 210. DBMS 110 provides the capability to store, organize, modify, and extract information from database virus database 108. Virus database 102 includes a collection of information relating to computer malwares, which are organized in such a way that computer software can select and retrieve desired pieces of data. Operating system 210 provides overall system functionality.

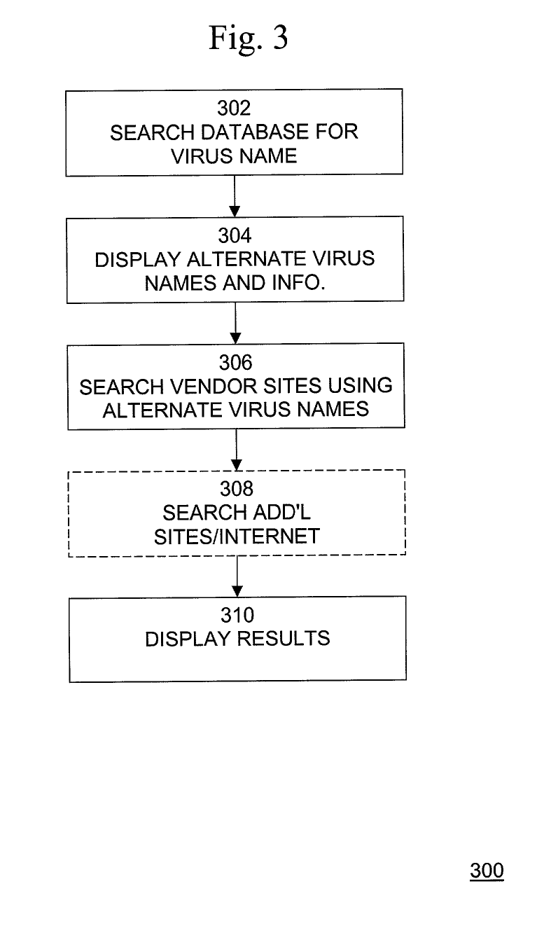

An exemplary flow diagram of a process 300 of operation of the virus cross reference system of the present invention is shown in FIG. 3. Process 300 begins with step 302, in which the virus database is searched to find a particular virus name entered by a user of the virus cross reference system. The virus database is generated using data from a plurality of anti-virus programs and vendors and preferably, is updated periodically. The virus database includes virus names, which may be searched, alternate virus names for each virus, descriptive information relating to each virus, and links to vendor sites at which information may be found relating to each virus, the vendor's anti-virus programs, the handling of each virus by the vendor's anti-virus programs, etc.

In step 304, alternate virus names used by a plurality of anti-virus programs for the virus that was the subject of the search are displayed, along with descriptive information relating to the virus. In step 306, the links to sites operated by vendors of the anti-virus programs are accessed, and the vendor sites searched using the respective alternate virus names for vendor-provided information relating to the virus. For example, the vendor provided information may include additional descriptive information relating to the virus, information relating to the vendor's anti-virus programs, information relating to the handling of each virus by the vendor's anti-virus programs, etc.

In step 308, which is optionally performed at the request of the user, Web sites in addition to the anti-virus program vendor sites are searched. A limited or specified number of additional sites may be searched, or, at the user's request, a general search of the Internet may be performed. Such searches are preferably performed by search engines, which are commonly available for use. The search may be performed using the name of the computer virus, an alternate name of the computer virus, or both

In step 310, the results of the searches of the vendor Web sites and any additional Web sites are displayed. Preferably, the results of the searches of each vendor Web site are displayed in association with the alternate virus name used by that vendor and the results of searches of additional Web sites are displayed as appropriate.

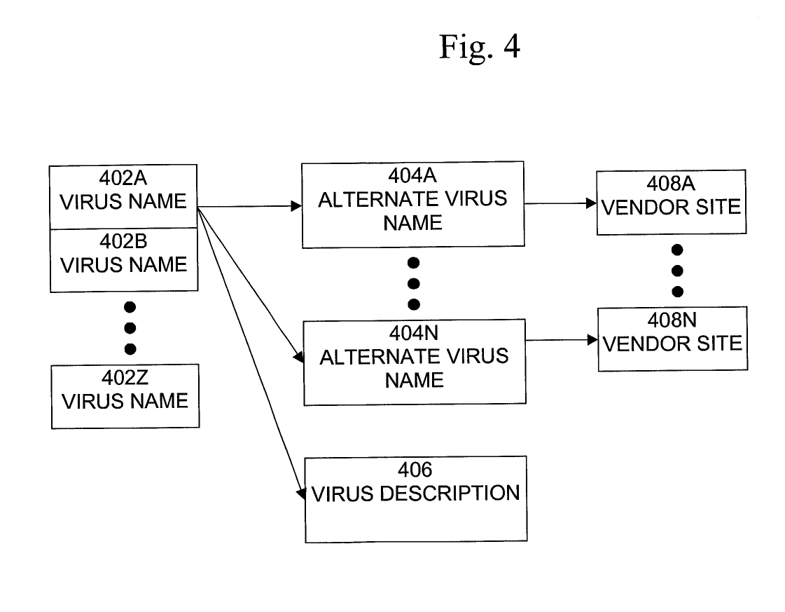

An exemplary format of an embodiment of virus database 108, shown in FIG. 1, is shown in FIG. 4. Database 108 includes a plurality of virus names, such as virus names 402A-Z. Each virus name may be associated with one or more alternative virus names, which are names given to the virus by vendors of anti-virus programs. For example, virus name 402A is associated with alternate virus names 404A-N. In addition, virus name 402A is associated with virus description information 406. Each alternate virus name is associated with a link to a Web site operated by a vendor of an anti-virus program that uses the alternate virus name.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of cross-referencing computer malwares, comprising the steps of:
searching a database for a name of a computer malware;
retrieving at least one alternate name of the computer malware; and
providing a link associated with the at least one alternate name.

2. The method of claim 1, further comprising the step of:
searching a Web site pointed to by the link for information relating to the computer malware using the alternate name.

3. The method of claim 2, wherein the computer malware comprises at least one of a computer virus, a computer worm, or a computer Trojan horse program.

4. The method of claim 2, further comprising the step of:
retrieving a description of the computer malware.

5. The method of claim 2, further comprising the step of:
displaying the information relating to the computer malware found using the alternate name.

6. The method of claim 2, further comprising the step of:
searching at least one additional Web site using the name of the computer malware.

7. The method of claim 2, further comprising the step of:
searching at least one additional Web site using at least one alternate name of the computer malware.

8. The method of claim 2, further comprising the step of:
performing a general search of the Internet using the name of the computer malware.

9. The method of claim 2, further comprising the step of:
performing a general search of the Internet using at least one alternate name of the computer malware.

10. The method of claim 2, further comprising the step of:
performing a general search of the Internet using a plurality of alternate names of the computer malware.

11. The method of claim 4, further comprising the step of:
displaying the information relating to the computer malware found using the alternate name.

12. The method of claim 11, further comprising the step of:
searching at least one additional Web site using the name of the computer malware.

13. The method of claim 11, further comprising the step of:
searching at least one additional Web site using at least one alternate name of the computer malware.

14. A method of cross-referencing computer malwares, comprising the steps of:
searching a database for a name of a computer malware;
retrieving a plurality of alternate names of the computer malware; and
providing a link associated with each alternate name.

15. The method of claim 14, further comprising the step of:
searching a Web site pointed to by the link for information relating to the computer malware using the alternate name.

16. The method of claim 15, wherein the computer malware comprises at least one of a computer virus, a computer worm, or a computer Trojan horse program.

17. The method of claim 15, further comprising the step of:
retrieving a description of the computer malware.

18. The method of claim 15, further comprising the step of:
displaying the information relating to the computer malware found using the alternate name.

19. The method of claim 15, further comprising the step of:
performing a general search of the Internet using at least one alternate name of the computer malware.

20. The method of claim 15, further comprising the step of:
performing a general search of the Internet using a plurality of alternate names of the computer malware.

21. The method of claim 17, further comprising the step of:
displaying the information relating to the computer malware found using the alternate name.

22. The method of claim 21, further comprising the step of:
performing a general search of the Internet using at least one alternate name of the computer malware.

23. The method of claim 21, further comprising the step of:
performing a general search of the Internet using a plurality of alternate names of the computer malware.

24. A system for cross-referencing computer malwares comprising:
a processor operable to execute computer program instructions;
a memory operable to store computer program instructions executable by the processor; and
computer program instructions stored in the memory and executable to perform the steps of:
searching a database for a name of a computer malware;
retrieving at least one alternate name of the computer malware; and
providing a link associated with the at least one alternate name.

25. The method of claim 24, further comprising the step of:
searching a Web site pointed to by the link for information relating to the computer malware using the alternate name.

26. The method of claim 25, wherein the computer malware comprises at least one of a computer virus, a computer worm, or a computer Trojan horse program.

27. The system of claim 25, further comprising computer program instructions to perform the step of:
retrieving a description of the computer malware.

28. The system of claim 25, further comprising computer program instructions to perform the step of:
displaying the information relating to the computer malware found using the alternate name.

29. The system of claim 25, further comprising computer program instructions to perform the step of:
searching at least one additional Web site using the name of the computer malware.

30. The system of claim 25, further comprising computer program instructions to perform the step of:
searching at least one additional Web site using at least one alternate name of the computer malware.

31. The system of claim 25, further comprising computer program instructions to perform the step of:
performing a general search of the Internet using the name of the computer malware.

32. The system of claim 25, further comprising computer program instructions to perform the step of:
performing a general search of the Internet using at least one alternate name of the computer malware.

33. The system of claim 25, further comprising computer program instructions to perform the step of:
performing a general search of the Internet using a plurality of alternate names of the computer malware.

34. The system of claim 27, further comprising computer program instructions to perform the step of:
displaying the information relating to the computer malware found using the alternate name.

35. The system of claim 34, further comprising computer program instructions to perform the step of:
searching at least one additional Web site using the name of the computer malware.

36. The system of claim 34, further comprising computer program instructions to perform the step of:
searching at least one additional Web site using at least one alternate name of the computer malware.

37. A system for cross-referencing computer malwares comprising:
a processor operable to execute computer program instructions;
a memory operable to store computer program instructions executable by the processor; and
computer program instructions stored in the memory and executable to perform the steps of:
searching a database for a name of a computer malware;
retrieving a plurality of alternate names of the computer malware; and
providing a link associated with each alternate name.

38. The method of claim 37, further comprising the step of:
searching a Web site pointed to by the link for information relating to the computer malware using the alternate name.

39. The method of claim 38, wherein the computer malware comprises at least one of a computer virus, a computer worm, or a computer Trojan horse program.

40. The system of claim 38, further comprising computer program instructions to perform the step of:
retrieving a description of the computer malware.

41. The system of claim 38, further comprising computer program instructions to perform the step of:
displaying the information relating to the computer malware found using the alternate name.

42. The system of claim 38, further comprising computer program instructions to perform the step of:
performing a general search of the Internet using at least one alternate name of the computer malware.

43. The system of claim 38, further comprising computer program instructions to perform the step of:
performing a general search of the Internet using a plurality of alternate names of the computer malware.

44. The system of claim 40, further comprising computer program instructions to perform the step of:
displaying the information relating to the computer malware found using the alternate name.

45. The system of claim 44, further comprising computer program instructions to perform the step of:
performing a general search of the Internet using at least one alternate name of the computer malware.

46. The system of claim 44, further comprising computer program instructions to perform the step of:
performing a general search of the Internet using a plurality of alternate names of the computer malware.

47. A computer program product for cross-referencing computer malwares, comprising:
a computer readable medium;
computer program instructions, recorded on the computer readable medium, executable by a processor, for performing the steps of
searching a database for a name of a computer malware;
retrieving at least one alternate name of the computer malware; and
providing a link associated with the at least one alternate name.

48. The method of claim 47, further comprising the step of:
searching a Web site pointed to by the link for information relating to the computer malware using the alternate name.

49. The method of claim 48, wherein the computer malware comprises at least one of a computer virus, a computer worm, or a computer Trojan horse program.

50. The computer program product of claim 48, further comprising computer program instructions for performing the step of:
retrieving a description of the computer malware.

51. The computer program product of claim 48, further comprising computer program instructions for performing the step of:
displaying the information relating to the computer malware found using the alternate name.

52. The computer program product of claim 48, further comprising computer program instructions for performing the step of:
searching at least one additional Web site using the name of the computer malware.

53. The computer program product of claim 48, further comprising computer program instructions for performing the step of:
searching at least one additional Web site using at least one alternate name of the computer malware.

54. The computer program product of claim 48, further comprising computer program instructions for performing the step of:
performing a general search of the Internet using the name of the computer malware.

55. The computer program product of claim 48, further comprising computer program instructions for performing the step of:
performing a general search of the Internet using at least one alternate name of the computer malware.

56. The computer program product of claim 48, further comprising computer program instructions for performing the step of:
performing a general search of the Internet using a plurality of alternate names of the computer malware.

57. The computer program product of claim 50, further comprising computer program instructions for performing the step of:
displaying the information relating to the computer malware found using the alternate name.

58. The computer program product of claim 57, further comprising computer program instructions for performing the step of:
searching at least one additional Web site using the name of the computer malware.

59. The computer program product of claim 57, further comprising computer program instructions for performing the step of:
searching at least one additional Web site using at least one alternate name of the computer malware.

60. A computer program product of cross-referencing computer malwares, comprising the steps of:
searching a database for a name of a computer malware;
retrieving a plurality of alternate names of the computer malware;
providing a link associated with each alternate name.

61. The method of claim 60, further comprising the step of:
searching a Web site pointed to by the link for information relating to the computer malware using the alternate name.

62. The method of claim 61, wherein the computer malware comprises at least one of a computer virus, a computer worm, or a computer Trojan horse program.

63. The computer program product of claim 61, further comprising computer program instructions for performing the step of:
retrieving a description of the computer malware.

64. The computer program product of claim 61, further comprising computer program instructions for performing the step of:
displaying the information relating to the computer malware found using the alternate name.

65. The computer program product of claim 61, further comprising computer program instructions for performing the step of:
performing a general search of the Internet using at least one alternate name of the computer malware.

66. The computer program product of claim 61, further comprising computer program instructions for performing the step of:
performing a general search of the Internet using a plurality of alternate names of the computer malware.

67. The computer program product of claim 63, further comprising computer program instructions for performing the step of:
displaying the information relating to the computer malware found using the alternate name.

68. The computer program product of claim 67, further comprising computer program instructions for performing the step of:
performing a general search of the Internet using at least one alternate name of the computer malware.

69. The computer program product of claim 67, further comprising computer program instructions for performing the step of:
performing a general search of the Internet using a plurality of alternate names of the computer malware.

70. A computer malware cross-reference comprising:
a plurality of names of computer malwares;
at least one alternate name of a computer malware associated with at least one of the plurality of names of computer malwares; and
at least one link to a Web site associated with the at least one alternate name of the computer malware.

71. The method of claim 70, wherein the computer malware comprises at least one of a computer virus, a computer worm, or a computer Trojan horse program.

72. The computer malware cross-reference of claim 70, further comprising a description of the computer malware.
